(19) United States
(12) Patent Application Publication
(10) Pub. No.: US 2022/0098813 A1
(43) Pub. Date: Mar. 31, 2022

(54) PRESSURIZATION THERMO-SENSITIVE GASIFICATION PHASE CHANGE CONSOLIDATION AND THERMAL DESENSITIZATION INTERMITTENT EVAPORATOR USING SAME

(71) Applicant: Jiangsu Xintai Geotechnical Technology Co., Ltd., Wuxi (CN)

(72) Inventor: Yawei JIN, Wuxi (CN)

(21) Appl. No.: 17/165,975

(22) Filed: Feb. 3, 2021

Related U.S. Application Data
(63) Continuation of application No. PCT/CN2020/140472, filed on Dec. 29, 2020.

(30) Foreign Application Priority Data
Sep. 27, 2020 (CN) 202011033577.4

(51) Int. Cl. E02D 3/11; B01D 1/00; B01D 1/06

(52) U.S. Cl. CPC E02D 3/11; E02D 2250/0053; B01D 1/06; B01D 1/0017

(57) ABSTRACT

The disclosure provides a thermal desensitization intermittent evaporator. The thermal desensitization intermittent evaporator includes a shell and at least one heating body disposed in the shell, wherein the heating body includes an electrical heating body and a wire connecting the electrical heating body, the wire is lead out from the shell to connect a power source; the electrical heating body includes a heating tube base and a metal joint mounted on the top of the heating tube base, the heating tube base includes upper and lower two bases, the upper base is a conductive low-heat-conduction material, and the lower base is a conductive heat-generating material. The disclosure can realize intermittent heating and high-pressure steam injection, thereby improving the activity of a water molecule, rapidly flowing to a low-temperature area and improving the efficiency of consolidation.

### TECHNICAL FIELD

The disclosure relates to the technical field of soft soil foundation treatment of geotechnical engineering, particularly to a pressurization thermo-sensitive gasification phase change consolidation method and a thermal desensitization intermittent evaporator using the same.

### BACKGROUND

In the fields of geotechnical engineering and environmental protection engineering, there are often problems of tight deadline and limited construction technology with respect to large-area soft soil foundation reinforcement treatment and environmental-friendly in-situ restoration works. The existing technology has many construction processes, however, prevalently has phenomena of low bearing capability, large construction cost, long construction period, difficultly controlled construction quality and the like. Therefore, when it is needed to shorten the construction period and greatly decrease the construction cost, the above conventional construction method has many technical problems that are difficult to overcome. The Chinese patent CN107190729A discloses a foundation evaporator and a construction method for heating a foundation by using a device combined with vacuum preloading treatment of a soft soil foundation. A vertical plastic drainage plate is arranged in the foundation, and the head of the vertical plastic drainage plate is connected with transversely arranged filter pipes, and the outlet ends of all the filter pipes are communicated with the inlet of a pressure-guide diversion device. An evaporator is also arranged in the foundation, and a sand cushion layer is laid on the foundation. The filter pipes are buried in the sand cushion layer, and a thermal insulation layer is laid on the sand cushion layer, and a sealing film is laid on the thermal insulation layer to form a closed vacuum preloading system. During the work, first of all, the pressure-guide diversion device is turned on to carry out foundation reinforcement using a conventional vacuum preloading method; when the conventional drainage consolidation is carried out to the later stage, the temperature-controlled heat-generating body is turned on to heat the foundation and meanwhile vacuumize the foundation. By controlling the heating temperature of the foundation and the absolute pressure of the foundation, the water in the foundation is changed from a liquid state to a gaseous state, so as to further reduce the water content of the foundation and enhance the strength of the foundation. The technical solution also adopts a vacuum preloading method and arranges a foundation heating device for heating, but the structure of the heating device can not realize intermittent heating and can only conduct simple electrical heating, and therefore it has low heating efficiency and needs further improvement.

### SUMMARY

For the above defects existing in the prior art, the object of the disclosure is to provide a pressurization thermo-sensitive gasification phase change consolidation method and a thermal desensitization intermittent evaporator using the same, so as to realize intermittent heating and high-pressure steam injection, thereby improving the activity of water molecules, rapidly flowing to a low-temperature area and improving the efficiency of consolidation.

In order to realize the object of the disclosure, the following technical solution is provided: a pressurization thermo-sensitive gasification phase change consolidation method, comprising the following steps:

S1, disposing a thermal desensitization intermittent evaporator in the bottom area of a vacuum preloading drainage plate in a sludge reinforced area, and starting heating;

S2, heating to 100˜400° C., maintaining for 3˜120 min, and then stopping for 6˜240 min, vacuumizing so that the pressure is larger than or equal to 80 kPa, and repeating the above intermittent heating process;

S3, when the liquid limit index of the surrounding reinforced soil is <0.98, and stopping heating, so as to complete gasification consolidation.

Preferably, when heating, the thermal desensitization intermittent evaporator injects high-pressure steam.

The function of intermittent heating used in step S2 is to allow water molecules to re-enter the shell after the high-pressure steam is injected again and then injected out in a manner of high temperature and high-pressure steam again when heating again to provide the diffusion radius of heat, thereby improving the efficiency of consolidation.

In order to realize the object of the disclosure, provided is a thermal desensitization intermittent evaporator for the pressurization thermo-sensitive gasification phase change consolidation method, comprising a shell and at least one heating body disposed in the shell, the heating body comprising an electrical heating body and a wire connecting the electrical heating body, and the wire being lead out from the shell to connect a power source, wherein the electrical heating body comprises a heating tube base and a metal joint mounted on the top of the heating tube base, the heating tube base comprises upper and lower two bases, the upper base is a conductive low-heat-conduction material, the lower base is a conductive heat-generating material, and the upper base is connected with the metal joint.

Arrangement of the conductive low-heat-conduction material and the conductive heat-generating material of the heating tube base can effectively prevent the burnout of the wire due to too-high temperature so as to prevent short circuit.

Preferably, a gas injection hole is formed in the shell, or the shell is a ceramic micropore sleeve.

Preferably, the conductive low-heat-conduction material is graphite.

Preferably, the conductive heat-generating material is quartz or silicon carbon.

Preferably, the conductive low-heat-conduction material and the conductive heat-generating material are molded by compaction sintering.

Preferably, the metal joint of the heating tube base is wrapped with a sealing insulation material.

Preferably, the sealing insulation material is high-temperature silica gel or resin to prevent electric leakage or short circuit caused by the entrance of water.

Preferably, a flame-retardant thermal-insulation material is filled around the upper base of the heating tube base.

Preferably, the flame-retardant thermal-insulation material is asbestos or light-weight foam brick.

Preferably, a high-heat-conduction granular refractory material is filled around the lower base of the heating tube base. The selection of the high-heat-conduction granular refractory material is to effectively produce and inject high-pressure steam when heating in order to fill water between particles in the shell, and to facilitate inhaling of sufficient water when stopping to be convenient for the next injection.

Preferably, the high-heat-conduction granular refractory material is quartz sand or magnesia.

Preferably, the gas injection hole is formed on the shell at the lower base of the heating tube base.

In order to achieve the object of the disclosure, provided is another thermal desensitization intermittent evaporator for the pressurization thermo-sensitive gasification phase change consolidation method, comprising a shell and at least one heat-generating body disposed in the shell, wherein a gas injection hole is formed in the shell.

Preferably, the heat-generating body comprises an electrical heating body and a wire connecting the electrical heating body, and the wire is lead out from the shell to connect a power source.

Preferably, the electrical heating body comprises a heating tube base and a metal joint mounted on the top of the heating tube base, the metal joint connects the wire, the heating tube base comprises upper and lower two bases, the upper base is a conductive non-heat-conduction material, the lower base is a conductive heat-generating material, and the upper base is connected with the metal joint.

Preferably, the conductive non-heat-conduction material is graphite.

Preferably, the conductive heat-generating material is quartz or silicon carbon.

Preferably, the conductive non-heat-conduction material and the conductive heat-generating material are molded by compaction sintering.

Preferably, the metal joint of the heating tube base is wrapped with a sealing insulation material.

Preferably, the sealing insulation material is high-temperature silica gel or resin.

Preferably, a flame-retardant thermal-insulation material is filled around the upper base of the heating tube base.

Preferably, the flame-retardant thermal-insulation material is asbestos or light-weight foam brick.

Preferably, a high-heat-conduction granular refractory material is filled around the lower base of the heating tube base.

Preferably, the high-heat-conduction granular refractory material is quartz sand or magnesia.

Preferably, the gas injection hole is formed on the shell at the lower base of the heating tube base.

The disclosure has the beneficial effects that the thermal desensitization intermittent evaporator is embedded under a silting and blocking prevention drainage plate for the purpose of further heating and gasifying underground pore water, accelerating phase change consolidation of a mud body, and improving the bearing capacity of the foundation so as to greatly reduce investment cost. Therefore, by implementing the technical solution, the purposes of “reducing time, reducing cost and increasing efficiency” can be well achieved, and the curing time is 1/20˜ 1/10 times of that of the common vacuum preloading method.

### BRIEF DESCRIPTION OF THE DRAWINGS

FIG. 1 is a structural diagram of an intermittent evaporator in example 6.

FIG. 2 is a structural diagram of an intermittent evaporator in example 7.

FIG. 3 is a structural diagram of an intermittent evaporator in example 8.

### DESCRIPTION OF THE EMBODIMENTS

Next, the technical solution in embodiments of the disclosure will be clearly and completely described in combination with drawings in the embodiments of the disclosure. Obviously, the described embodiments are only some embodiments of the disclosure but not all the embodiments. Based on the embodiments of the disclosure, all other embodiments obtained by persons of ordinary skill in the art without creative efforts are included within the scope of protection of the disclosure.

Example 1: a pressurization thermo-sensitive gasification consolidation method combined with a method (ZL200810156787.5) for pressurization vacuum preloading consolidation treatment of soft soil and a drainage plate and filter cloth for consolidation of sludge and a drainage plate core (ZL200910181702.3) includes the following steps:

S1, disposing the thermal desensitization intermittent evaporator in the bottom area of a vacuum preloading drainage plate in a sludge reinforced area, and starting heating, and injecting the high-pressure steam from the thermal desensitization intermittent evaporator when heating;

S2, heating to 200° C., maintaining for 6 min, and then stopping for 12 min, vacuumizing until the pressure reached 90 kPa, and repeating the above intermittent heating process;

S3, when the liquid limit index of the surrounding reinforced soil was <0.98, and stopping heating, so as to complete gasification consolidation.

Referring to example 1, examples 2˜5 are as shown in Table below:

| | Heating | Maintaining | Stopping |
|---|---|---|---|
| Number | temperature ° C. | time min | time min |
| Example 2 | 100 | 60 | 120 |
| Example 3 | 160 | 120 | 240 |
| Example 4 | 300 | 8 | 16 |
| Example 5 | 400 | 3 | 6 |

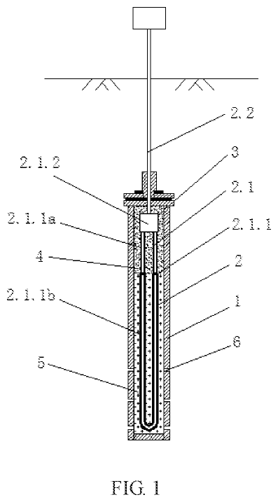

Example 6: as shown in FIG. 1, a thermal desensitization intermittent evaporator for a pressurization thermo-sensitive gasification consolidation method included a shell 1 and 2 heating bodies disposed in the shell 1, the heating body 2 including an electrical heating body 2.1 and a wire 2.2 connecting the electrical heating body 2.1, the wire 2.2 being lead out from the shell 1 to connect a power source, wherein the electrical heating body 2.1 included a heating tube base 2.1.1 and a metal joint 2.1.2 mounted on the top of the heating tube base 2.1.1, the metal joint 2.1.2 connected the wire 2.2, the heating tube base 2.1.1 included upper and lower two bases 2.1.1a and 2.1.1b, the upper base 2.1.1a was graphite, the lower base 2.1.1b was quartz, and the upper base 2.1.1a was connected with the metal joint 2.1.1. The whole heating tube base 2.1.1 was molded in quartz and graphite moulds via compaction sintering, the metal joint 2.1.2 of the heating tube base 2.1.1 was wrapped with high-temperature silica gel 3, and asbestos 4 was filled around the upper base 2.1.1a of the heating tube base 2.1.1. The magnesia 5 was filled around the lower base 2.1.1b of the heating tube base 2.1.1, and a gas injection hole 6 was formed on the shell 1 at the lower base 2.1.1b of the heating tube base 2.1.1.

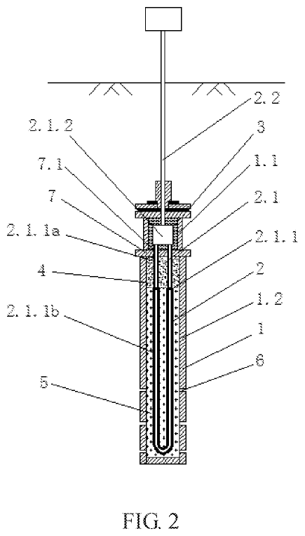

Example 7: as shown in FIG. 2, referring to example 6, the shell 1 was divided into upper and lower parts 1.1 and 1.2 between which a baffle 7 was arranged for spacing, the baffle 7 was provided with a spliced eye 7.1, the heating tube base 2.1.1 was inserted into the spliced eye 7.1 to be fixed, and the metal joint 2.1.2 was located in the upper shell 1.1. The breakage of the heating tube base in the shell due to displacement was effectively prevented. The refractory material was easy to break off because of its strong rigidity.

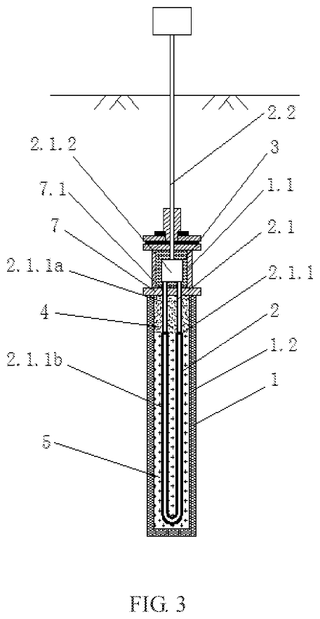

Example 8: as shown in FIG. 3, referring to example 7, the lower shell 1.2 was a ceramic micropore sleeve, the upper shell 1.1 was carbon steel, the cap on the top of the upper shell 1.1 was sealed, and the cap was provided with a sealing device.

The existing consolidation theory is a Terzaghi's theory more than 100 years ago, namely, water molecules are dissipated by virtue of pore pressure, and water cannot be dissipated to a certain extent. In the disclosure, the thermal desensitization intermittent evaporator is arranged at the bottom of the vacuum preloading drainage plate to generate superheated steam to be injected around under high temperature and high pressure so that the water molecule is improved in activity and quickly flows to the low temperature area, the permeation coefficient is doubled if the temperature is raised by 10° C., the superheated steam is generated in the later to be dissipated to the surrounding soil, and water molecules in vacuum environment are gasified at 45° C. so that the water content in soil is rapidly reduced. Vacuum preloading is from flowing plastic to soft plastic. The high-temperature high-pressure steam makes the sludge (sewage sludge) soft plastic and then hard plastic. The strength of the soil is multiplied. The intermittent effect is to allow water molecules to re-enter an object, and then to be injected out in a way of high-temperature high-pressure steam when heating again so as to improve the diffusion radius of heat, thereby improving the efficiency of consolidation.

What is claimed is:

1. A thermal desensitization intermittent evaporator, comprising: a shell and at least one heating body disposed in the shell, the heating body comprising an electrical heating body and a wire connecting the electrical heating body, the wire being lead out from the shell to connect a power source, wherein the electrical heating body comprises a heating tube base and a metal joint mounted on the top of the heating tube base, the metal joint connects the wire, the heating tube base comprises upper and lower two bases, the upper base is a conductive low-heat-conduction material, the lower base is a conductive heat-generating material, and the upper base is connected with the metal joint.

2. The thermal desensitization intermittent evaporator according to claim 1, wherein a gas injection hole is formed in the shell, or the shell is a ceramic micropore sleeve.

3. The thermal desensitization intermittent evaporator according to claim 1, wherein the conductive low-heat-conduction material is low-heat-conduction graphite.

4. The thermal desensitization intermittent evaporator according to claim 1, wherein the conductive heat-generating material is quartz or silicon carbon.

5. The thermal desensitization intermittent evaporator according to claim 1, wherein the conductive low-heat-conduction material and the conductive heat-generating material are molded by compaction sintering.

6. The thermal desensitization intermittent evaporator according to claim 1, wherein the metal joint of the heating tube base is wrapped with a sealing insulation material.

7. The thermal desensitization intermittent evaporator according to claim 6, wherein the sealing insulation material is high-temperature silica gel or resin.

8. The thermal desensitization intermittent evaporator according to claim 1, wherein a flame-retardant thermal-insulation material is filled around the upper base of the heating tube base.

9. The thermal desensitization intermittent evaporator according to claim 8, wherein the flame-retardant thermal-insulation material is asbestos or light-weight foam brick.

10. The thermal desensitization intermittent evaporator according to claim 1, wherein a high-heat-conduction granular refractory material is filled around the lower base of the heating tube base.

11. The thermal desensitization intermittent evaporator according to claim 10, wherein the high-heat-conduction granular refractory material is quartz sand or magnesia.

12. The thermal desensitization intermittent evaporator according to claim 2, wherein the gas injection hole is formed on the shell at the lower base of the heating tube base.

13. The thermal desensitization intermittent evaporator according to claim 1, wherein the upper base is a conductive non-heat-conduction material.
